(19) United States
(12) Patent Application Publication
(10) Pub. No.: US 2013/0042855 A1
(43) Pub. Date: Feb. 21, 2013

(54) COOKWARE SPLASH GUTTER

(71) Applicant: Jesman Mutangadura, Arlington, TX (US)

(72) Inventor: Jesman Mutangadura, Arlington, TX (US)

(21) Appl. No.: 13/214,190

(22) Filed: Aug. 21, 2011

(51) Int. Cl. A47J 27/58

(52) U.S. Cl. 126/385.1

(57) ABSTRACT

The present invention is directed to a device for capturing liquid splash and overflow during the cooking process. The splash gutter comprises a seal region, a reservoir region, and a deflector region. The seal region defines a perimeter of an aperture dimensioned for receipt of cookware. The seal region is operable to conform to the outer surface of a sidewall of cookware. The reservoir region is joined to the seal region, with the reservoir region having a first end downwardly depending from the seal region to a bottom and rising to a second end, defining a reservoir therein. The deflector region is joined to the reservoir region, the deflector region depending upwardly from the second end of the reservoir region.

### BACKGROUND

1. Field of the Invention

The present invention relates to cookware, more specifically to a device for capture of liquid overflow from cookware.

2. Description of the Related Art

During the cooking process, liquids are frequently added to foodstuff and brought to a simmer or boil. At or near those temperatures, the liquid composition becomes turbulent causing the liquid to overflow or splash from the cookware. Water, grease, sauces, or other liquids can splash or overflow from the cookware during the stove top, oven, or microwave cooking processes. Moreover, liquids may splash or overflow in moving the cookware, causing a safety concern. The liquid overflow can be a concern, requiring active monitoring during cooking or other concerns. A person can monitor the cookware for liquid overflow and address the overflow. However, this extra attention may be impractical or undesirable, especially in larger scale food preparation environments.

Failure to monitor the cookware during cooking leads to other concerns. The liquid overflow can travel down the outer sidewall of the cookware and contact the heat source, affecting the heat output. In the preparation of a single batch, the liquid overflow can lead to uneven heating of the foodstuff, thus lowering the food quality, producing unwanted odors, or requiring more attention during the cooking process. In the medium term, the liquid overflow can lead to the requirement for more frequent cleaning of the cooking surface, heat source, and related elements. In the long term, the liquid overflow can damage the heat source, leading to a shortened life cycle for parts such as heating elements.

Lids have been used to attempt to address the problem but fail to do so. First, lids restrict access to the foodstuff being cooked. Moreover, the lids without a seal fail because they still permit liquid overflow to some extent.

For the above reasons, there is a need for a device for use during cooking which is readily engaged to cookware, allows reasonable access to the foodstuff, and captures liquid splash and overflow.

### SUMMARY

The present invention is directed to a device for capturing liquid splash and overflow during the cooking process. The splash gutter comprises a seal region, a reservoir region, and a deflector region. The seal region defines a perimeter of an aperture dimensioned for receipt of cookware. The seal region is operable to conform to the outer surface of a sidewall of cookware. The reservoir region is joined to the seal region, with the reservoir region having a first end downwardly depending from the seal region to a bottom and rising to a second end, defining a reservoir therein. The deflector region is joined to the reservoir region, the deflector region depending upwardly from the second end of the reservoir region.

These and other features, aspects, and advantages of the invention will become better understood with reference to the following description, appended claims, and accompanying drawings.

### BRIEF DESCRIPTION OF THE DRAWINGS

FIG. 1 depicts a top perspective view of an embodiment of the invention;

FIG. 2 depicts a cross-sectional view of an embodiment of the invention;

FIG. 3 depicts a top perspective view of an embodiment of the invention;

FIG. 4 depicts a top perspective view of an embodiment of the invention;

FIG. 5 depicts a cross-sectional profile of a reservoir region of an embodiment of the invention;

FIG. 6 depicts an alternative cross-sectional profile of a reservoir region of an embodiment of the invention; and

FIG. 7 depicts a top perspective view of an embodiment of the invention.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

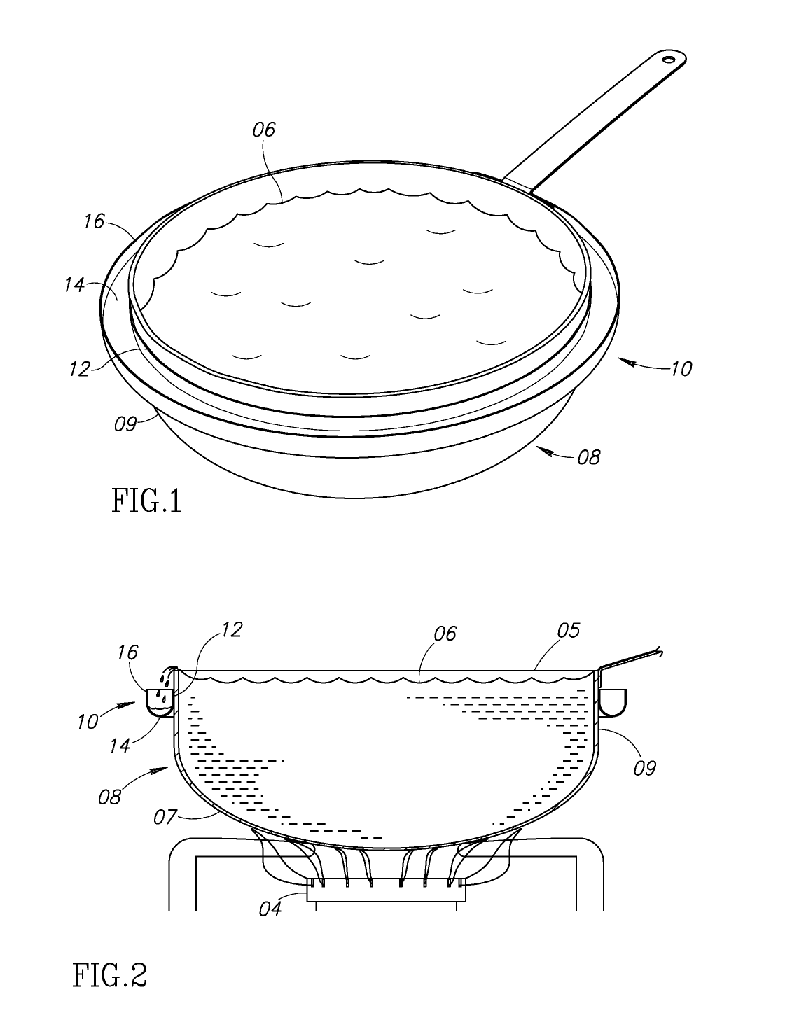

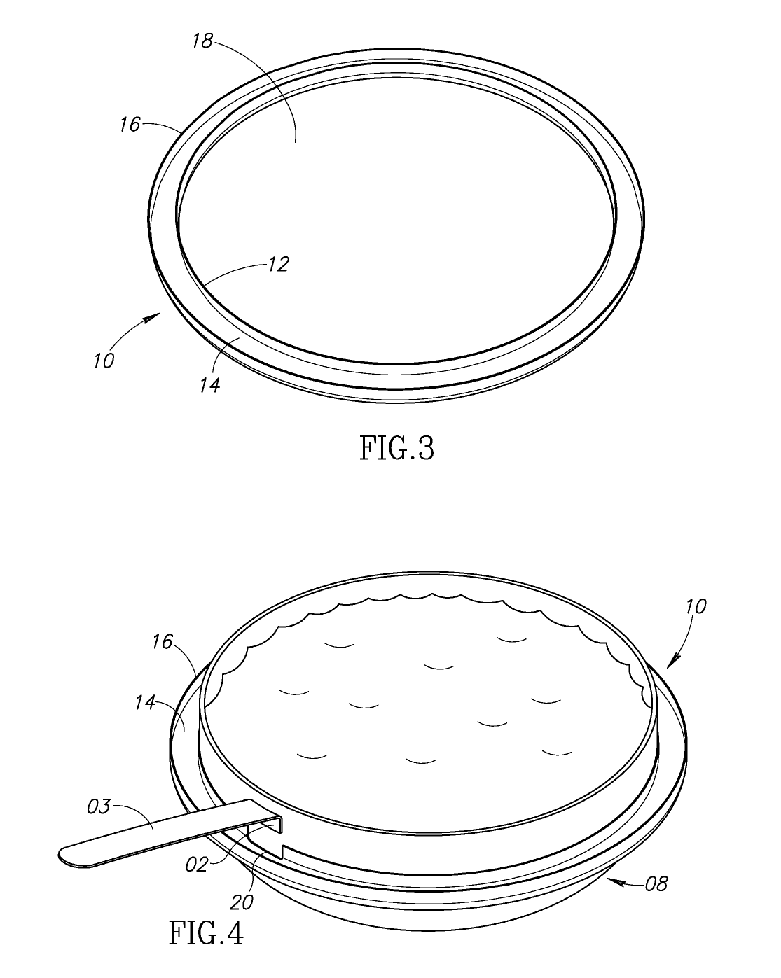

The current invention includes cookware 08 with a splash gutter 10 to capture liquid splash or overflow during the cooking and preparation process. Referring to FIG. 1, an embodiment of the invention 10 is illustrated. Illustrated are cookware 08 and a splash gutter 10. The cookware 08 includes a bottom wall 07 and at least one sidewall 09 extending upwardly from the bottom wall 07. The upper end of the sidewall 09 presents a rim which defines the perimeter of an open top end of the cookware 08 in which foodstuff and liquid may be introduced. When viewed from above, the cross-sectional profile of the cookware 08 may take a variety of shapes, such as a circle, square, rectangle, or other polygons. As shown in FIG. 1, the sidewall 09 is configured annularly.

The splash gutter 10 is configured to be removably mated to the cookware 08, preferably at the rim presented by the sidewall 09 of the cookware 08. The splash gutter 10 can be dimensioned for cookware 08 of a particular geometry and dimension. A single splash gutter 10 can be configured to mate with cookware 08 of slightly different dimensions due to characteristics such as elasticity. Accordingly, the splash gutter 10 geometry corresponds to the cookware 08 with which it is mated. The illustrated splash gutter 10 of FIG. 1 is semi-toroidal, although it can take other geometries, as illustrated in other figures. The splash gutter 10 includes a seal region 12, a reservoir region 14, a deflector region 16, and an inner periphery 18.

The outer bound of the inner periphery 18 of the splash gutter 10 is dimensioned to encompass the sidewall 09 of the cookware 08. The seal region 12 defines the perimeter of the inner periphery 18 and is dimensioned for slideable engagement to the outer surface of the sidewall 09. At least a portion of the seal 12 abuts the sidewall 09, conforming to the outer surface of the sidewall 09, presenting a barrier to liquid traveling from the open end of the cookware 08 along the outer surface of the sidewall 09. The seal region 12 downwardly depends from the sidewall 09. Optionally, a portion of the seal region 12 can be flexible and a portion of the seal 12 can depend angularly and outwardly relative to the sidewall 09 in order to alter liquid overflow properties or enable a single splash gutter 10 to mate with cookware 08 of varying dimensions. The seal region 12 is preferably semi-elastic, but can be composed of more rigid materials.

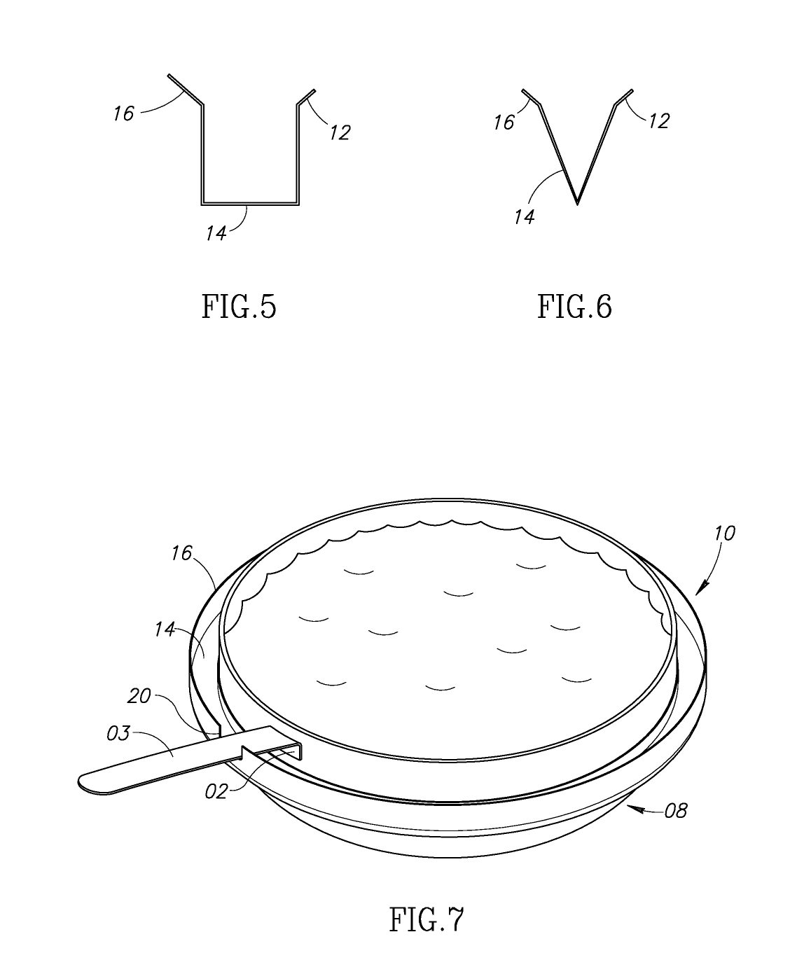

Joined to the seal region 12 is a reservoir region 14. From a first end, the reservoir region 14 extends downwardly from the seal region 12 to a bottom and then rises upwardly to a second end. The interior formed presents a reservoir operative to contain liquid therein. The cross-sectional profile of the reservoir region 14 can take the curvilinear configuration of FIG. 2 or alternate configurations, such as the angular configurations depicted in FIGS. 5 and 6. The lateral distance from the first end of the reservoir region 14 to the second end is configured to provide a suitable capture zone for liquid splashing from the cookware. Additionally, the depth from the first and seconds ends of the reservoir region 14 to its bottom is configurable to provide a desired volume for captured liquid.

The deflector region 16 is operative to direct splashed liquid to the reservoir region 14. The deflector region 16 depends upwardly from the second end of the reservoir region 14. The deflector region 16 can be dimensioned such that its terminal point is lower, higher, or at the same height as the peak height of the seal region 12. Additionally, the deflector region's 16 angular orientation relative to the cookware is configurable. The deflector region 16 is preferably oriented at about 90 degrees from the plane 05 defined by the surface of a liquid 06 contained in the cookware 08. In alternate configurations, the deflector region 16 is oriented at an obtuse angle relative to the plane 05 defined by the surface of a liquid contained in the cookware 08, providing a larger capture zone.

The splash gutter 10 presents a capture zone for capturing liquid splash or overflow from the cookware 08 at varying distances and manner. The innermost area of the capture zone is seal region 12, which captures liquid overflow traveling from the open end of the cookware 08 along the outer surface of the sidewall 09. The central area of the capture zone is the reservoir region 14, which captures liquid ejected from the open end of the cookware 08. The outermost area of the capture zone is the deflector region 16, which captures liquid ejected yet further from the open end of the cookware 08. Where the overflow or ejected liquid is captured at the seal region 12 or the deflector region 16, it flows into the reservoir region 14.

As shown in FIGS. 4 and 7, the splash gutter 10 optionally includes a slot 20 operable to slidably receive a portion of the handle 03. The slot 20 includes a recess where the width and depth of the recess are dimensioned to slidably receive the portion of the handle 03. In one configuration, the slot 20 includes a recess in the seal region 12. In a second configuration, the slot includes a recess in the seal region 12 and a recess in the deflector region 16. In this second configuration, the recess of the deflector region 16 is proximate the recess of the seal region 12 in order to receive a distal portion of the handle 03. In a third configuration, the slot 20 includes a recess in the deflector region 16.

Both the cookware 08 and splash gutter 10 may be composed of material suitable for cooking and the disclosed functionality. Suitable materials include, but are not limited to, aluminum, copper, steel, iron, ceramics, glass, composites, or other materials known in the art for stove top, oven, microwave, or other cooking means. Preferably, the splash gutter 10 is composed of silicone.

Referring to FIG. 2, the use of the device is shown. The foodstuff and liquid are introduced to the cookware 08. The splash gutter 10 is slidably engaged to the cookware 08. The heat source 04 is applied to the cookware 08 and the foodstuff is cooked. The overflow and splashed liquid is collected in the capture zone of the splash gutter 10. After the cooking process, the splash gutter 10 is disengaged from the cookware 08 and the captured liquid is removed.

Insofar as the description above and the accompanying drawing disclose any additional subject matter that is not within the scope of the claims below, the inventions are not dedicated to the public and the right to file one or more applications to claim such additional inventions is reserved.

What is claimed is:

1. A device for capturing liquid splash and overflow during the cooking process comprising:
a splash gutter comprising a seal region, a reservoir region, and a deflector region;
said seal region defining a perimeter of an aperture dimensioned for receipt of said cookware;
said seal region operable to conform to the outer surface of a sidewall of cookware;
said reservoir region joined to said seal region, said reservoir region having a first end downwardly depending from said seal region to a bottom and then rising to a second end, defining a reservoir therein; and
said deflector region joined to said reservoir region, said deflector region depending upwardly from said second end of said reservoir region.

2. The device of claim 1 wherein at least a portion of said seal region is flexible.

3. The device of claim 1 wherein said seal region is annular.

4. The device of claim 1 wherein at least a portion of said seal region depends angularly and outwardly from said perimeter.

5. The device of claim 1 wherein said reservoir region comprises a curvilinear cross-section.

6. The device of claim 1 wherein said reservoir region comprises an angular cross-section.

7. The device of claim 1 wherein said deflector region is oriented angularly relative to the plane formed by the upper surface of said cookware.

8. The device of claim 1 wherein said deflector region is oriented substantially orthogonally relative to the plane formed by the upper surface of said cookware.

9. The device of claim 1 wherein said deflector region is oriented at an obtuse angle relative to the plane formed by the upper surface of said cookware.

10. The device of claim 1 further comprising a slot, said slot further comprising a recess in said seal region.

11. The device of claim 1 further comprising a slot, said slot further comprising a first recess in said seal region and a second recess in said deflector region, said second recess disposed proximate said first recess.

12. The device of claim 1 further comprising a slot, said slot further comprising a recess in said deflector region.

13. A device for capturing liquid overflow during the cooking process comprising:
cookware and a splash gutter;
said cookware comprising a bottom wall and at least one sidewall extending upwardly from the bottom wall;
said splash gutter comprising a seal region, a reservoir region, and a deflector region;
said seal region defining a perimeter of an aperture dimensioned for receipt of cookware;
said seal region operable to conform to the outer surface of a sidewall of cookware;
said reservoir region joined to said seal region, said reservoir region having a first end downwardly depending from said seal region to a bottom and then rising to a second end, defining a reservoir therein; and
said deflector region joined to said reservoir region, said deflector region depending upwardly from said second end of said reservoir region.

14. The device of claim 13 wherein at least a portion of said seal region is elastic.

15. The device of claim 13 wherein said seal region is annular.

16. The device of claim 13 wherein at least a portion of said seal region depends angularly and outwardly from said perimeter.

17. The device of claim 13 wherein said reservoir region comprises a curvilinear cross-section.

18. The device of claim 13 wherein said reservoir region comprises an angular cross-section.

19. The device of claim 13 wherein said deflector region is oriented angularly relative to the plane formed by the upper surface of said cookware.

20. The device of claim 13 wherein said deflector region is oriented substantially orthogonally relative to the plane formed by the upper surface of said cookware.

21. The device of claim 13 wherein said deflector region is oriented at an obtuse angle relative to the plane formed by the upper surface of said cookware.

22. The device of claim 13 further comprising a slot, said slot further comprising a recess in said seal region.

23. The device of claim 13 further comprising a slot, said slot further comprising a first recess in said seal region and a second recess in said deflector region, said second recess disposed proximate said first recess.

24. The device of claim 13 further comprising a slot, said slot further comprising a recess in said deflector region.
